(19) United States
(12) Patent Application Publication
(10) Pub. No.: US 2008/0110038 A1
(43) Pub. Date: May 15, 2008

(54) SYSTEM AND METHOD FOR HIDDEN OBJECT DETECTOR WITH LEVEL

(75) Inventor: Oleksiy P. Sergyeyenko, Brockville (CA)

Correspondence Address: HARNESS, DICKEY & PIERCE, P.L.C., P.O. BOX 828, BLOOMFIELD HILLS, MI, 48303, US

(73) Assignee: BLACK & DECKER INC., Newark, DE (US)

(21) Appl. No.: 11/936,593

(22) Filed: Nov. 7, 2007

Related U.S. Application Data
(60) Provisional application No. 60/865,812, filed on Nov. 14, 2006.

(51) Int. Cl. G01C 9/26

(52) U.S. Cl. 33/334; 33/347

(57) ABSTRACT

A detector level system for use with a work-piece is provided. The system can include a clam shell housing with a first shell and a second shell that define a set of lateral walls and a cavity. The set of lateral walls can define two parallel planes. The system can include a hidden object detector retained within the cavity and operable to detect an object hidden by the work-piece. The system can further include at least one bubble level retained in the cavity. The at least bubble level can be disposed between the parallel planes and visible through apertures formed in the set of lateral walls. The system can include at least one magnet coupled to one of the first shell, or second shell. The at least one magnet can be operable to enable the detector level system to be coupled to a metallic material.

### CROSS-REFERENCE TO RELATED APPLICATION

This application takes priority from U.S. Patent Application No. 60/865,812 filed Nov. 14, 2006. The disclosure of the above application is incorporated herein by reference.

### INTRODUCTION

The present invention relates generally to a hidden object detector, and more particularly to a system and method for a hidden object detector with a level.

Traditionally, hidden object detectors have been employed to assist operators in locating objects behind a wall, such as studs or live wires, after a wall surface has been installed. Levels have been employed to assist operators in the alignment of objects on wall surfaces, or in the assembly of objects to wall surfaces, such as shelving.

Typically, however, hidden object detectors and levels are separate and discrete devices such that an operator must first locate the hidden object, such as a stud, beneath the wall surface, and then must either mark the location of the hidden object or attach the desired object to the wall surface prior to the use of the level. Thus, by using separate and discrete hidden object detectors and levels, the user is unable to visualize the alignment of the object prior to mounting the object on the wall surface. In addition, at times it would be desirable to have a compact hidden object detector with one or more levels to enable an operator to both determine the location of an object beneath the surface of the wall and properly align and mount an object to a wall with the use of a single tool.

Accordingly, it would be desirable to provide a device, such as a hidden object detector, that is capable of identifying the an object beneath a wall surface and that further includes one or more levels that can indicate a required alignment for positioning an object with respect to the wall surface.

A detector level system for use with a work-piece is provided. The system can include a clam shell housing with a first shell and a second shell that define a set of lateral walls and a cavity. The set of lateral walls can define two parallel planes. The system can include a hidden object detector retained within the cavity and operable to detect an object hidden by the work-piece. The system can further include at least one bubble level retained in the cavity. The at least bubble level can be disposed between the parallel planes and visible through apertures formed in the set of lateral walls. The system can include at least one magnet coupled to one of the first shell, or second shell. The at least one magnet can be operable to enable the detector level system to be coupled to a metallic material.

Further provided is a detector level system for use with a work-piece. The system can include a clam shell housing with a first shell, a second shell and a support structure that define a cavity and a uniform marking surface when assembled. The system can also include the support structure coupled to the first shell and the second shell such that at least a portion of the support structure is positioned within the cavity. The system also can include a hidden object detector received in the housing that can be operable to detect an object hidden by the work-piece. The system can further include a first bubble level coupled to at least one of the first shell, second shell, and support structure such that the first bubble level is disposed between the first shell and second shell. The first bubble level can be visible through apertures formed in at least one of the first and second shell and the support structure.

A detector level system for use with a work-piece is also provided. The system can include a clam shell housing with a first shell and second shell that define a cavity, and a first level support. The system also can include a metal support structure coupled to the housing and at least partially disposed within the cavity. The system also can include a hidden object detector received in the housing, which can be operable to detect an object hidden by the work-piece. The system also can include a first bubble level coupled to the first level support such that the first bubble level can be disposed within the housing.

A detector level system for use with a work-piece is provided. The system can include a clam shell housing with a first shell and a second shell that define a cavity and at least one level support. The system also can include a metal support structure coupled to the housing and at least partially disposed within the cavity. The support structure can include a mount and a longitudinally extending groove. At least a portion of the longitudinally extending groove can have a pair of transverse surfaces when viewed in a cross-section that is taken perpendicular to the longitudinally extending groove. The system can include a hidden object detector received in the mount, which can be operable to detect an object hidden by the work-piece. The system further can include at least one bubble level coupled to the at least one level support such that the at least one bubble level is disposed within the housing.

A detector level system for use with a work-piece is provided. The system can include a clam shell housing with a first shell and a second shell that define a cavity, a first level support and a second level support. The first shell and a second shell can define a uniform marking surface when assembled. The system also can include a metal support structure coupled to the housing and at least partially disposed within the cavity. The support structure can include a mount. The system also can include a hidden object detector received in the mount, which can be operable to detect an object hidden by the work-piece. The system also can include a first bubble level coupled to the first level support such that the first bubble level can be disposed within the housing. The system further includes a second bubble level coupled to the second level support such that the second bubble level can be disposed within the housing.

Further areas of applicability of the present teachings will become apparent from the detailed description provided hereinafter. It should be understood that the detailed description and specific examples, while indicating various embodiments of the present teachings, are intended for purposes of illustration only and are not intended to limit the scope of the present teachings.

### BRIEF DESCRIPTION OF THE DRAWINGS

The present invention will become more fully understood from the detailed description and the accompanying drawings, wherein:

FIG. 1 is an environmental view of an exemplary hidden object detector with a level according to various teachings;

FIG. 2 is a second environmental view of an exemplary hidden object detector with a level according to various teachings;

FIG. 3 is a perspective view of the an exemplary hidden object detector of FIG. 1;

FIG. 4 is an exploded view of the hidden object detector of FIG. 1;

FIG. 5 is an end view of the hidden object detector of FIG. 1;

FIG. 6 is a top view of the hidden object detector of FIG. 1; and

FIG. 7 is a side view of the hidden object detector of FIG. 1.

### DETAILED DESCRIPTION OF THE VARIOUS EMBODIMENTS

The following description of various embodiments is merely exemplary in nature and is in no way intended to limit the present teachings. Although the following description is related generally to a hidden object detector including one or more levels, it will be understood that the hidden object detector and/or the level, as described and claimed herein, can be used in combination with any appropriate tool, such as a light detector. Therefore, it will be understood that the following discussions are not intended to limit the scope of the appended claims.

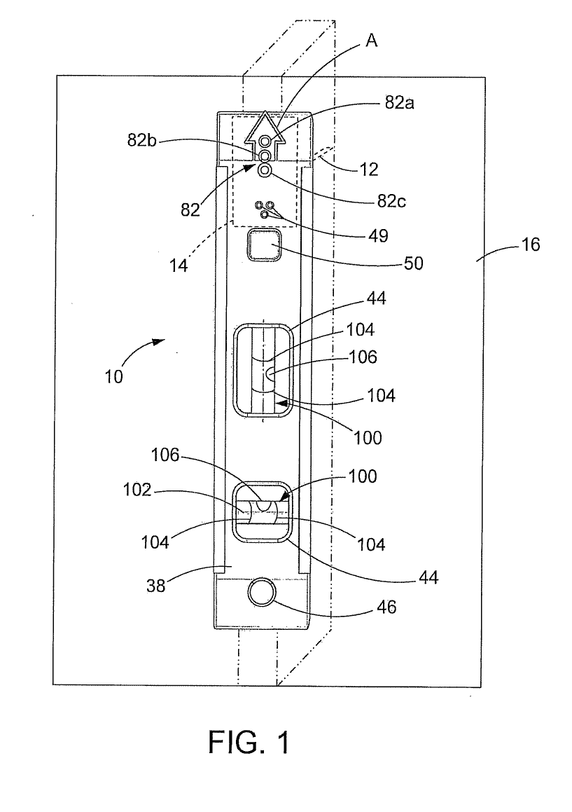

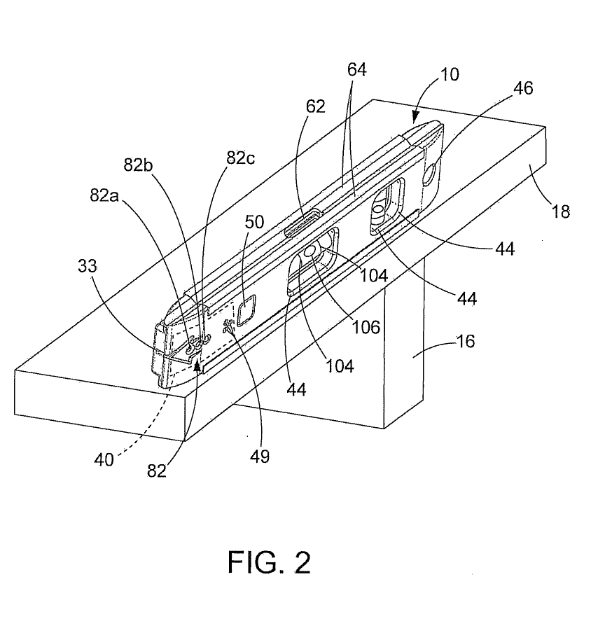

With reference to FIG. 1, an exemplary detector level system 10 is shown. The detector level system 10 can be used to detect a location of an object, such as a stud 12, behind a wall surface 16. In addition, as shown in FIG. 2, the detector level system 10 can be used to determine if an object, such as a shelf 18, is level the wall surface 16. It should be understood, however, that although the detector level system 10 is described herein as being used to locate objects behind a wall surface, and to determine if a planar object is level with regard to a wall surface, the detector level system 10 could be used in any environment where it is desirable to either locate a hidden object and/or to determine if an object is level with respect to another surface.

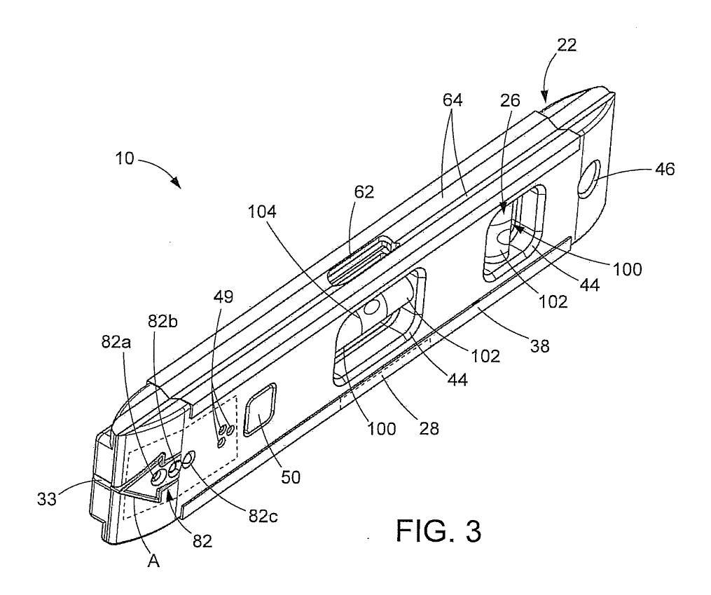

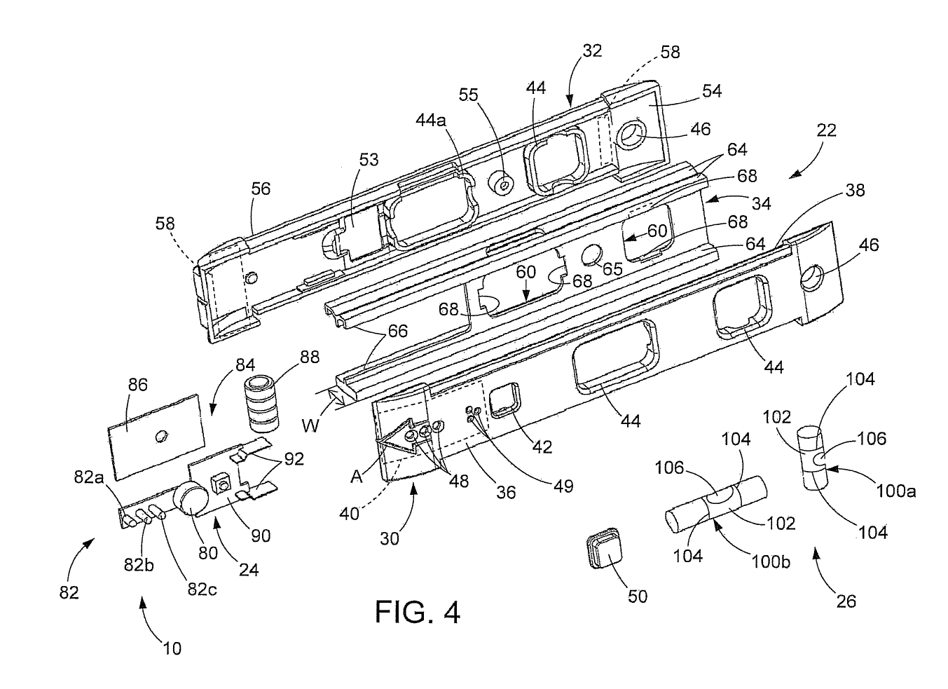

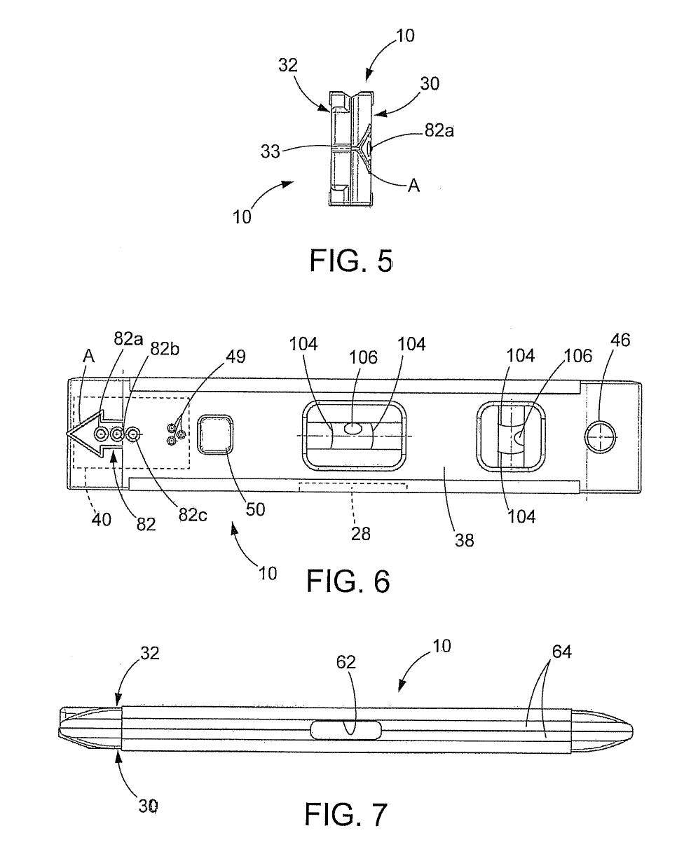

With additional reference to FIG. 3, the detector level system 10 can include a housing 22 that can house a detector system 24, a level system 26 and a magnet 28. With reference now to FIG. 4, the housing 22 can include a first shell 30, a second shell 32 and a support structure 34. The first shell 30 and second shell 32, when assembled, as best shown in FIG. 5, can form a groove 33 to enable the user to mark the location of the object on the wall surface 16. With reference back to FIG. 4, the first shell 30 and second shell 32 can be comprised of a polymeric material, while the support structure 34 can be composed of a metal or metal alloy. However, it will be noted that the support structure 34 could be composed of a polymeric material, and further that the first shell 30 and second shell 32 can each be integrally formed to include the support structure 34, if desired. Generally, the first shell 30 has a slight concave contour, while the second shell 32 can be substantially planar.

The first shell 30 can include a first surface 36 and a second surface 38. The first shell 30 can also define a visual indicator surface 40, a user input receptacle 42, level apertures 44 and a mounting aperture 46. The visual indicator surface 40 can include one or more apertures 48 for receipt of visual indicators from the detector system 24, and can include apertures 49 to enable audible noise to pass through the first shell 30, as will be discussed herein. The visual indicator surface 40 can also include markings, such as an arrow A, that can be used in conjunction with the detector system 24 to indicate a location of the hidden object to the user.

The user input receptacle 42 can define an aperture through which a user input device 50, such as a pushbutton, can extend to enable the user to activate the detector system 24, as will be discussed. The level apertures 44 can be configured to enable the user to view the level system 26. The mounting aperture 46 can be formed at an end of the housing 22, generally at an end of the housing 22 opposite the visual indicator surface 40, and can enable the user to hang the detector level system 10 when not in use. The second surface 38 can be configured to mate with both the second shell 32 and a support structure 34, and can define a threaded bore, not shown, for receipt of a mechanical fastener, such as a screw, to couple the second shell 32 and support structure 34 to the first shell 30.

With continuing reference to FIG. 4, the second shell 32 can include a first surface 54 and a second surface 56. The second shell 32 can also include an access panel 53, the level apertures 44 and the mounting aperture 46. As the second shell 32 can be substantially identical to the first shell 30, only the differences between the second shell 32 and the first shell 30 will be discussed herein. In addition, the same references will be used to denote the same or similar components. The first surface 54 can be configured to mate with the support structure 34, and can include one or more screw bosses 55 to couple both the second shell 32 and the support structure 34 as will be discussed herein. The second surface 56 can include one or more pads 58 to enable the detector level system 10 to be moved over the wall surface 16, for example, without marking the wall surface 16. The access panel 53 can enable the user to access the detector system 24, as will be discussed herein.

The support structure 34 can be coupled between the first shell 30 and the second shell 32 via the screw boss 55. The support structure 34 can have a width W that can be sized such that the detector system 24 and level system 26 can fit between the first shell 30 and second shell 32. The support structure 34 can include level supports 60, a viewing aperture 62, one or more grooves 64, a throughbore 65 and arms 66. The level supports 60 can couple and retain the level system 26 in the detector level system 10. The level supports 60 can define notches 68 for receipt of the level system 26, however, any appropriate mechanism, such as bonding or adhesives, could be used to couple the level system 26 to the detector level system 10.

The viewing aperture 62 can enable the user to view the level system 26, as shown best in FIG. 7. The grooves 64 can enable the detector level system 10 to be used on concave surfaces, such as pipes, by defining a U-shaped region between the first shell 30 and second shell 32 such that the user can position the detector level system 10 adjacent to a concave surface (not shown). With reference back to FIG. 4, the throughbore 65 can enable a bolt to pass from the screw boss 55 of the second shell 32 to the first shell 30 to couple both the second shell 32 and the support structure 34 to the first shell 30. The arms 66 can support the detector system 24 within the housing 22.

The detector system 24 can be supported by the support structure 34 in the housing 22. The detector system 24 can include an audible indicator 80 and one or more visual indicators 82 each in communication with a sensing system 84. The audible indicator 80 can comprise a speaker to provide an audible tone or message to a user that an object is hidden behind the wall surface 16 through the apertures 49 of the housing 22, for example. As the audible indicator 80 can be a conventional speaker, the audible indicator 80 will not be described in great detail herein. Briefly, however, the audible indicator 80 can provide an audible indicator of a status of the detector system 24 based on a voltage received from the sensing system 84, as will be discussed. For example, the sensing system 84 can generate a voltage to the audible indicator that results in a tone being broadcasted through the audible indicator 80 that is indicative of the detection of an object, such as the stud 12 (FIG. 1), beneath the wall surface 16.

With reference to FIG. 4, the visual indicators 82 can be coupled to and in communication with the sensing system 84 to provide a user with a visual indication of whether an object, such as the stud 12 (FIG. 1), is beneath the wall surface 16. Generally, the visual indicators 82 can be coupled to the sensing system 84 such that the visual indicators 82 can be received into visual indicator surface 40 of the first shell 30 (FIG. 1). The visual indicators 82 can be responsive to a voltage received from the sensing system 84 to output visible light. The visual indicators 82 can comprise any visual light emitting device, such as a light emitting diode (LED). The visual indicators 82 can include a first visual indicator 82a, a second visual indicator 82b and a third visual indicator 82c. It should be noted that the reference numeral 82 will be used herein to denote all of the visual indicators 82a, 82b, 82c. The visual indicators 82 can output the visual light to indicate whether the stud 12 is beneath the wall surface 16 adjacent to the detector level system 24.

For example, the first visual indicator 82a can output a particular color, such as “green,” to indicate that an object has been detected under the wall surface 16. Generally, the first visual indicator 82a can be located on the visual indicator surface 40 so that the user can easily determine that an object has been detected, such as near an end of the visual indicator surface 40, near a peak of the arrow A. The second visual indicator 82b can output a particular color, such as “yellow,” to indicate that an object is close to being detected under the wall surface 16. The third visual indicator 82c can output a particular color, such as “red,” to indicate that an object is not detected under the wall surface 16.

The sensing system 84 can include a sensing device 86, a power source 88 and the user input device 50, each in communication with a PCB 90, as illustrated in FIG. 4. The sensing device 86 can be in communication with the PCB 90 to enable the PCB 90 to determine if an object is beneath the wall surface 16. For example, the sensing device 86 could comprise a capacitive plate, if the detector level system 10 is employed to detect the location of a stud beneath the wall surface 16. If the capacitive plate is employed as the sensing device 86, the PCB 90 can provide the sensing device 86 with a selected current, and based on the capacitance received from the sensing device 86, the PCB 90 can determine if an object is located beneath the wall surface 16, as will be discussed. In addition, the sensing device 86 could comprise a coil in order to detect metal beneath the wall surface 16 or a device capable of detecting live wire beneath the wall surface 16 (not shown). Additionally, the sensing system 84 could be configured with a manner that is similar to that which is described in U.S. Pat. No. 4,464,622, entitled “Electronic Wall Stud Sensor”, filed on Mar. 11, 1982 and incorporated by reference herein in its entirety. Alternatively, the sensing system 84 could be configured with a manner that is similar to that disclosed in U.S. Pat. No. 4,853,617, entitled “Apparatus Having Capacitive Sensor And Metal Detector For Detecting Objects Concealed Behind Surfaces”, filed on Mar. 24, 1987, or that disclosed in U.S. Pat. No. 4,992,741 entitled “Capacitive Sensor And Metal Detector With A Display For Quantitatively Displaying Signals Resulting From Concealed Objects,” filed on Jun. 30, 1989, each of which are hereby incorporated by reference in their entirety.

The power source 88 can output a desired voltage to the PCB 90. The power source 88 can be coupled to the housing 22. Generally, the power source 88 can comprise one or more batteries, however, the power could be provided to the PCB 90 through a power cord and associated circuitry (not shown). The PCB 90 can then provide power to the sensing device 86, as will be discussed herein. The PCB 90 can also provide power to activate the audible indicator 80 and the visual indicators 82.

The user input device 50 can enable the user to activate the sensing system 84. The user input device 50 can be in communication with the PCB 90, such that when the user depresses the user input device 50, the PCB 90 can activate the sensing system 84. The PCB 90 can be in communication with the user input device 50, the audible indicator 80, the visual indicators 82, the sensing device 86 and the power source 88. The PCB 90 can include circuitry to provide voltage to the audible indicator 80, the visual indicators 82 and the sensing device 86 from the power source 88 upon the depression of the user input device 50.

For example, the user input device 50, when depressed, can close a switch on the PCB 90 to enable current from the power source 88 to flow to the sensing device 86 (not shown). Based on the capacitance received from the capacitive plate 92, the PCB 90 can provide voltage to one of the visual indicators 82, depending upon the amount of capacitance received. For example, if the capacitance received was equivalent to the capacitance of the wall surface 16 without an object beneath it, then voltage can be provided to the third visual indicator 82c. If the capacitance received was equivalent to the capacitance of the wall surface 16 with an object beneath it, then voltage can be provided to the first visual indicator 82a, and can also be provided to the audible indicator 80.

If, however, the capacitance received was greater than the capacitance of the wall surface 16 without an object beneath it, but less than the capacitance of the wall surface 16 with an object beneath it, then voltage can be provided to the second visual indicator 82b. It should be noted that although a capacitance based detector system 24 is described herein, any suitable system could be employed to detect if an object is beneath a surface, such as a radar or sonar system.

The housing 22 can also house the level system 26. The level system 26 can include one or more vials 100. The vials 100 can include a fluid 102 and markings, such as lines 104, on the vials 100. Typically, the fluid 102 is contained in the vial 100 such that the vial 100 can be moved without the loss of fluid 102. Typically, the level system 26 can include two vials 100, one positioned vertically within the housing 22 (perpendicular to arms 66) and one positioned horizontally within the housing 22 (parallel to arms 66). Each of the vials 100 can be coupled to the level supports 60 in the respective level support 60 of the support structure 34. As is generally known, the fluid 102 can be partially filled in the vial 100 so that when the vial 100 is moved, a bubble 106 is formed in the fluid 102. Generally, with the vertically positioned vial 100a, the bubble 106 can be formed perpendicular to the arms 66 of the support structure 34. With regard to the horizontally positioned vial 100b, the bubble 106 can be formed parallel to the arms 66 of the support structure 34. The lines 104 can be spaced around a center of the vial 100 such that when the bubble 106 is positioned between the lines 104, the detector level system 10 is level with respect to the adjacent surface, as is generally known. It should be noted that although the level system 26 is described as being a mechanical level system 26, any suitable device, such as a laser level system, could be employed to determine if a surface is level.

The magnet 28 can be coupled to the housing 22, and can be coupled to the support structure 34, if desired. The magnet 28 can enable the detector level system 10 to be easily coupled to metallic materials, such as steel shelving or pipes. The magnet 28 can generally be a permanent magnet, however an electro-magnet could be employed if desired.

Thus, the detector level system 10 can enable the user to both determine the location of an object hidden beneath a surface, such as the wall surface 16 (FIG. 1), and can enable the user to determine if a surface is level (FIG. 2). In operation to determine if an object, such as the stud 12, is beneath the wall surface 16, the user can place the detector level system 10 adjacent to the wall surface 16 (FIG. 1). Then, the user can depress the user input device 50 to activate the detector system 24. When the user input device 50 is depressed, a switch on the PCB 90 can be closed, and voltage from the power source 88 can be provided to the sensing device 86 (FIG. 4). Based on the capacitance received from the sensing device 86, the PCB 90 can provide voltage to the visual indicators 82 and/or the audible indicator 80. In addition, the user can mark the wall surface 16 by aligning a marking object (not shown) with the groove 33 in the housing 22 (FIG. 5). In operation to determine if a surface of an object is level, the user can place the detector level system 10 adjacent to the surface and then re-position the detector level system 10 until the bubble 106 in the fluid 102 is aligned within the lines 104 (FIGS. 2 and 4).

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

For example, while the detector level system 10 has been described as including a groove 33 enabling a user to generate a marking on the wall surface, those of skill in the art will appreciate that the present disclosure, in its broadest aspects, may be constructed somewhat differently. For example, a marker device could be integrated into the housing 22 such that when the hidden object is detected by the detector system 24, the marking device marks the wall surface 16 to indicate the position of the hidden object with respect to the wall surface 16.

What is claimed is:

1. A detector level system for use with a work-piece comprising:
a clam shell housing with a first shell and a second shell that define a set of lateral walls and a cavity, the set of lateral walls defining two parallel planes;
a hidden object detector retained within the cavity and operable to detect an object hidden by the work-piece;
at least one bubble level retained in the cavity, the at least one bubble level being disposed between the parallel planes and visible through apertures formed in the set of lateral walls; and
at least one magnet coupled to one of the first shell or second shell, the at least one magnet operable to enable the detector level system to be coupled to a metallic material.

2. The system of claim 1, further comprising:
a metal support structure coupled to the first shell and the second shell such that at least a portion of the support structure is positioned within the cavity and at least one longitudinally extending groove defined by the support structure has a pair of transverse surfaces as viewed in a cross-section that is taken perpendicular to the longitudinally extending groove.

3. The system of claim 2, wherein the support structure includes a mount, and the housing defines at least one level support.

4. The system of claim 3, wherein the at least one bubble level further comprises:
a first bubble level coupled to a first one of the at least one level support such that the first bubble level is disposed between the first shell and the second shell.

5. The system of claim 4, wherein the at least one bubble level further comprises:
a second bubble level coupled to a second one of the at least one level support such that the second bubble level is disposed between the first shell and the second shell.

6. The system of claim 5, further comprising:
at least one indicator in communication with and responsive to the hidden object detector to indicate to a user that the object is hidden by the work-piece.

7. The system of claim 6, wherein the at least one indicator comprises at least one visual indicator, at least one audible indicator and combinations thereof.

8. A detector level system for use with a work-piece comprising:
a clam shell housing with a first shell, a second shell and a support structure that define a cavity and a uniform marking surface when assembled;
the support structure coupled to the first shell and the second shell such that at least a portion of the support structure is positioned within the cavity.
a hidden object detector received in the housing, the hidden object detector operable to detect an object hidden by the work-piece; and
a first bubble level coupled to at least one of the first shell, the second shell and the support structure such that the first bubble level is disposed between the first shell and the second shell, the first bubble level being visible through apertures formed in at least one of the first shell, the second shell and the support structure.

9. The system of claim 8, wherein the support structure is composed of a metal or metal alloy.

10. The system of claim 8, wherein the support structure further comprises at least one longitudinally extending groove that has a pair of traverse surfaces as viewed in a cross-section taken perpendicular to the longitudinally extending groove.

11. The system of claim 8, further comprising:
a second bubble level coupled to at least of the first shell, second shell and support structure such that the second bubble level is disposed between the first shell and the second shell.

12. The system of claim 8, further comprising:
at least one indicator in communication with and responsive to the hidden object detector to indicate to a user that the object is hidden by the work-piece, the at least one indicator comprising at least one visual indicator, at least one audible indicator and combinations thereof.

13. The system of claim 8, further comprising:
at least one magnet coupled to one of the first shell, second shell or support structure, the magnet operable to enable the detector level system to be coupled to a metallic material.

14. The system of claim 11, wherein when the clam shell housing is assembled, the uniform marking surface is formed adjacent to at least one of the first bubble level and the second bubble level.

15. A detector level system for use with a work-piece comprising:
a clam shell housing with a first shell and a second shell that define a cavity and a first level support;
a metal support structure coupled to the housing and at least partially disposed within the cavity;
a hidden object detector received in the housing, the hidden object detector operable to detect an object hidden by the work-piece; and
a first bubble level coupled to the first level support such that the first bubble level is disposed within the housing.

16. The system of claim 15, wherein the housing defines a second level support and the system further comprises:
a second bubble level coupled to the second level support such that the second bubble level is disposed between the first shell and the second shell.

17. The system of claim 16, wherein the support structure further comprises at least one longitudinally extending groove that has a pair of transverse surfaces as viewed in a cross-section taken perpendicular to the longitudinally extending groove.

18. The system of claim 15, further comprising:
at least one indicator in communication with and responsive to the hidden object detector to indicate to a user that the object is hidden by the work-piece, the at least one indicator comprising at least one visual indicator, at least one audible indicator and combinations thereof.

19. A detector level system for use with a work-piece comprising:
a clam shell housing with a first shell and a second shell that define a cavity and at least one level support;
a metal support structure coupled to the housing and at least partially disposed within the cavity, the support structure having a mount, at least one level support and a longitudinally extending groove, at least a portion of the longitudinally extending groove having a pair of transverse surfaces as viewed in a cross-section that is taken perpendicular to the longitudinally extending groove;
a hidden object detector received in the mount, the hidden object detector operable to detect an object hidden by the work-piece; and
at least one bubble level coupled to the at least one level support such that the at least one bubble level is disposed within the housing.

20. The system of claim 19, wherein the at least one bubble level further comprises:
a first bubble level coupled to a first one of the at least one level support such that the first bubble level is disposed between the first shell and the second shell.

21. The system of claim 19, wherein the at least one bubble level further comprises:
a second bubble level coupled to a second one of the at least one level support such that the second bubble level is disposed between the first shell and the second shell.

22. A detector level system for use with a work-piece comprising:
a clam shell housing with a first shell and a second shell that define a cavity, a first level support and a second level support, the first shell and the second shell define a uniform marking surface when assembled;
a metal support structure coupled to the housing and at least partially disposed within the cavity, the support structure having a mount, and at least one groove;
a hidden object detector received in the mount, the hidden object detector operable to detect an object hidden by the work-piece;
a first bubble level coupled to the first level support such that the first bubble level is disposed within the housing; and
a second bubble level coupled to the second level support such that the second bubble level is disposed within the housing.
